(19) United States
(12) Patent Application Publication
(10) Pub. No.: US 2006/0265188 A1
(43) Pub. Date: Nov. 23, 2006

(54) Methods and apparatus for defect reduction analysis

(75) Inventors: Ronal Richard French, Oronoco, MN (US); Brian Richard Lepel, Rochester, MN (US); Susan Eileen Skrabanek, Talking Rock, GA (US); Suzanne Elaine Smith, Hilo, HI (US); James Allen Walters, Byron, MN (US)

Correspondence Address: IBM Corporation;Intellectual Property Law Dept. 917, 3605 Hwy. 52 North, Rochester, MN, 55901, US

(73) Assignee: International Business Machines Corporation, Armonk, NY (US)

(21) Appl. No.: 11/122,799

(22) Filed: May 5, 2005

(51) Int. Cl. G06F 11/30

(52) U.S. Cl. 702/185

(57) ABSTRACT

In a first aspect, a first method is provided for providing a service for performing Orthogonal Defect Classification (ODC) analysis. The first method includes the steps of (1) querying a customer about a level of service desired for a customer defect analysis project; (2) configuring a customer defect data collection tool for ODC; (3) adapting a defect data transfer tool to transfer defect data from the defect data collection tool; (4) transferring the defect data to a database structured to be accessible by an ODC analysis tool; and (5) performing ODC analysis on the defect data using the ODC analysis tool. Numerous other aspects are provided.

### CROSS REFERENCE TO RELATED APPLICATION

The present application is related to U.S. patent application Ser. No. ______, filed on even date herewith and titled “METHODS AND APPARATUS FOR TRANSFERRING DATA” (Attorney Docket No. ROC920040336US1), which is hereby incorporated by reference herein in its entirety.

### FIELD OF THE INVENTION

The present invention relates generally to software testing, and more particularly to methods and apparatus for defect reduction analysis.

### BACKGROUND

In a conventional system, due to the complexity of a defect reduction analysis methodology such as Orthogonal Defect Classification (ODC), a substantial effort may be required to employ ODC for analyzing the system's defect data. Therefore, ODC may not be cost-effective. Consequently, many system owners are cost constrained to employ simpler defect analysis methodologies to analyze their data. However, such simpler defect analysis methodologies are not as robust as ODC, and therefore, do not yield as much useful information.

Accordingly, improved methods and apparatus for providing a defect reduction analysis methodology such as ODC are desired.

### SUMMARY OF THE INVENTION

In a first aspect of the invention, a first method is provided for providing a service for performing Orthogonal Defect Classification (ODC) analysis. The first method includes the steps of (1) querying a customer about a level of service desired for a customer defect analysis project; (2) configuring a customer defect data collection tool for ODC; (3) adapting a defect data transfer tool to transfer defect data from the defect data collection tool; (4) transferring the defect data to a database structured to be accessible by an ODC analysis tool; and (5) performing ODC analysis on the defect data using the ODC analysis tool.

In a second aspect of the invention, a second method is provided for deploying computing infrastructure, comprising integrating computer-readable code into a computing system. The code in combination with the computing system is capable of (1) adapting a defect data transfer tool to transfer defect data from a defect data collection tool; (2) transferring the defect data to a database structured to be accessible by an ODC analysis tool; and (3) performing ODC analysis on the defect data using the ODC analysis tool.

In a third aspect of the invention, a first system is provided for performing Orthogonal Defect Classification (ODC) analysis. The first system includes (1) a defect data transfer tool; (2) an ODC analysis tool; and (3) a database structured to be accessible by the ODC analysis tool coupled to the defect data transfer tool and the ODC analysis tool. The system is adapted to (a) adapt the defect data transfer tool to transfer defect data from a defect data collection tool; (b) transfer the defect data to the database structured to be accessible by the ODC analysis tool; and (c) perform ODC analysis on the defect data using the ODC analysis tool. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for performing defect data analysis in accordance with an embodiment of the present invention.

FIG. 2 illustrates a first exemplary method of providing a service for performing Orthogonal Defect Classification (ODC) analysis in accordance with an embodiment of the present invention.

FIG. 3 illustrates a process flow for a second exemplary method of providing a service for performing Orthogonal Defect Classification (ODC) analysis in accordance with an embodiment of the present invention.

### DETAILED DESCRIPTION

The present invention includes methods and apparatus for providing a service for performing a defect reduction methodology using Orthogonal Defect Classification (hereinafter “ODC”). In ODC the frequency of defects and defect trends are analyzed based on data collected during software testing. The method for providing the service may include querying a customer about the customer's desired level of involvement and details of the customer's defect analysis project. For example, the customer may desire the service provider (e.g., the assignee of the present invention, IBM Corporation of Armonk, N.Y.) to perform some, most or all of the work. Further, the customer's defect analysis project may be limited, complex, etc. According to the method for providing the service, a test tool employed by the customer to collect defect data may be adapted for ODC. A record transfer tool may be adapted to transfer defect data from the test tool. The defect data may then be transferred from the test tool to a database structured to be accessible by a defect data analysis tool (e.g., jMYSTIQ manufactured by the assignee of the present invention, IBM Corporation of Armonk, N.Y.), and ODC analysis may be performed on the defect data using the defect data analysis tool.

Typically, due to the complexity of ODC, a significant effort may be required by customers to employ ODC for analyzing defect data. Therefore, use of ODC may not be cost-effective. Consequently, many customers are cost constrained to employ simpler defect analysis methodologies to analyze their data. However, such simpler defect analysis methodologies are not as robust as ODC, and therefore, do not yield as much useful information. In contrast, through use of the present methods and apparatus for providing service, ODC is made available to customers without significant effort and cost. More specifically, the present invention may eliminate the need for a customer to configure ODC analysis tools such as jMYSTIQ. Therefore, the present invention enables customers to overcome the complexity of employing ODC to analyze their data. Consequently, the present invention makes ODC more broadly accessible in a cost-effective manner, thereby providing an industry-wide defect data analysis solution.

Further, the present invention provides methods and apparatus for deploying infrastructure adapted to reduce defects in software. More specifically, the present invention provides methods and apparatus for deploying infrastructure for adapting a defect data (e.g., record) transfer tool to transfer defect data from a defect data collection tool, transfer the defect data to a database structured to be accessible by an ODC analysis tool and perform ODC analysis on the defect data using the ODC analysis tool.

The present invention may also provide methods and apparatus in which a reusable configuration may be employed by the record transfer tool. Consequently, subsequent analyses of similar data may be performed with minimal additional configuration.

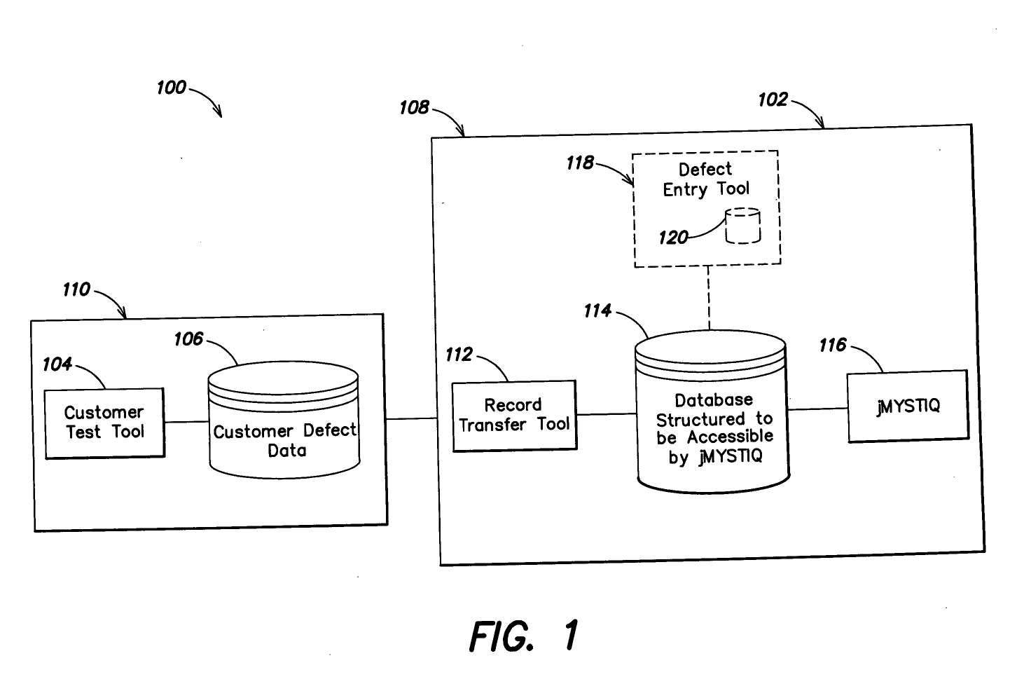

FIG. 1 is a block diagram of a system for performing defect data analysis in accordance with an embodiment of the present invention. With reference to FIG. 1, the system 100 (e.g., Defect Reduction Method (DRM) system) for performing defect data analysis in accordance with an embodiment of the present invention may include infrastructure 102 for performing defect data analysis. The infrastructure 102 may include and/or be coupled to a customer test tool 104 adapted to collect defect data (e.g., defect classification data), for example, during software testing and a customer database 106 coupled thereto and/or included therein adapted to store the collected defect data. In some embodiments, the infrastructure 102 may serve as a host 108 and the customer test tool 104 (e.g., defect data collection tool) and customer database 106 may serve as a client 110.

Further, the infrastructure 102 may include a record (e.g., defect data) transfer tool 112 coupled to a database 114 structured to be accessible by a defect data analysis test tool 116 coupled thereto. The record transfer tool 112 may be adapted to transfer data from a source, such a repository or depot, to a destination. For example, the record transfer tool 112 may transfer defect data from the customer database 106 to the database 114 structured to be accessible by the defect data analysis tool 116, and therefore, structured to be accessible by ODC. In some embodiments, Record Express may be employed as the record transfer tool 112. Record Express is manufactured by the assignee of the present invention, IBM Corporation of Armonk, N.Y. Details of Record Express are described in commonly-assigned, co-pending U.S. patent application Ser. No. ______, filed on even date herewith and titled “METHODS AND APPARATUS FOR TRANSFERRING DATA” (Attorney Docket No. ROC920040336US1), which is hereby incorporated by reference herein in its entirety. In some embodiments, the database 114 structured to be accessible by the defect data analysis tool 116 may be a relational database such as a DB2 database. For example, in some embodiments, Defect Central may be employed as the database 114. Defect Central is manufactured by the assignee of the present invention, IBM Corporation of Armonk, N.Y.

The defect data analysis tool 116 may be adapted to access the defect data stored in the database 114, validate the defect data and/or perform ODC analysis on such data. In some embodiments, jMYSTIQ may be employed as the defect data analysis tool 116. jMYSTIQ is manufactured by the assignee of the present invention, IBM Corporation of Armonk, N.Y.

The infrastructure 102 may be provided to a customer to perform ODC analysis on the customer's defect data. In this manner, the infrastructure 102 may reduce an amount of work required by the customer for performing ODC analysis on defect data.

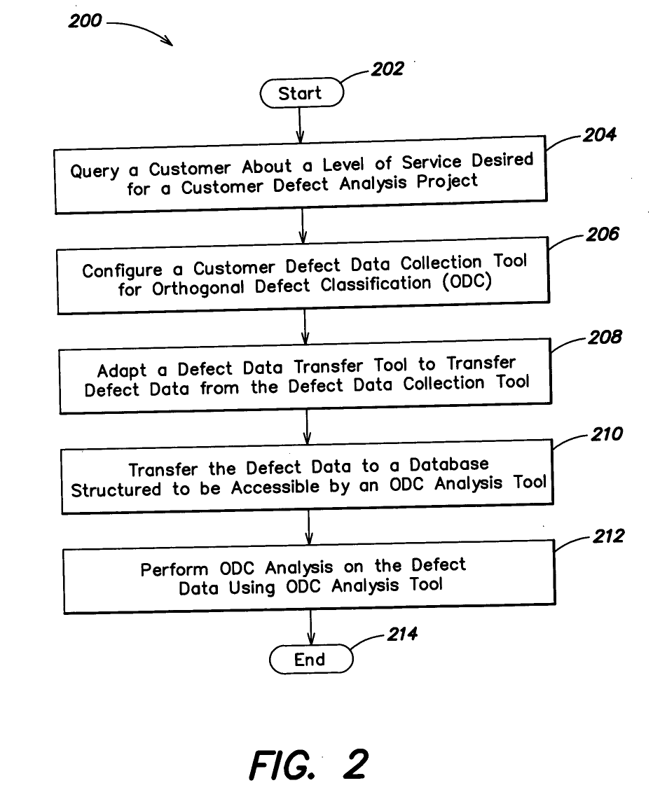

FIG. 2 illustrates a first exemplary method of providing a service for performing Orthogonal Defect Classification (ODC) analysis in accordance with an embodiment of the present invention. With reference FIG. 2, in step 202, the method 200 begins. In step 204, a customer is queried about a level of service desired for a customer defect analysis project. More specifically, the provider of the service for performing ODC analysis may query the customer about the customer's defect analysis project and/or about the customer's desired level of involvement in providing the service for performing ODC analysis. For example, the service provider may query the customer about the complexity level of their defect analysis project and/or whether the customer would like to do none, some or most of the work for providing the service for performing ODC analysis. In this manner, the service provider may customize the service to the customer's needs. Although the customer is queried about their defect analysis project and/or their desired level of involvement, the customer may be queried for a larger or smaller amount of information and/or different information.

In step 206, a customer defect data collection tool is configured for ODC. More specifically, the service provider may assist in configuring the customer's defect data collection tool 104 to collect and/or store data required by ODC, which may not have been collected and/or stored before the configuration. In this manner, the customer data collection tool 104 may serve as a defect management repository. The customer data collection tool 104 may vary in complexity based on customer needs. The service provider's role in configuring the customer defect data collection may vary. For example, in some embodiments, the service provider may train the customer who will thereafter configure the customer data collection tool 104 for ODC. Alternatively, the service provider may perform some, most or all of the work required to configure the customer data collection tool 104 for ODC.

In step 208, a defect data transfer tool is adapted to transfer defect data from the defect data collection tool. The service provider may configure the record transfer tool 112 to transfer defect data from the defect data collection tool 104 (e.g., the customer or database 106 coupled thereto and/or included therein) to the database 114 structured to be accessible by the defect data analysis tool 116. For example, the service provider may input settings to the record transfer tool 112 which affect the defect data transfer between the defect data collection tool 104 and the database 114 structured to be accessible by the defect data analysis tool 116. In some embodiments, based on the settings input by the service provider, the record transfer tool 112 may create a mapping between fields of data stored in the customer database 106 and fields of data stored in the database 114 structured to be accessible by the defect data analysis tool 116. The record transfer tool 112 may employ many permutations of mapping. For example, the record transfer tool 112 may map a single table from the customer database 106 to multiple tables in the database 114 structured to be accessible by the defect data analysis tool 116 (although other types of mapping may be employed).

Further, the record transfer tool 112 may receive other settings which may affect the defect data transfer between the defect data collection tool 104 and the database 114 structured to be accessible by the defect data analysis tool 116. Such settings may be based on information gathered during step 204 in which the customer is queried about a level of service desired for the customer defect analysis project. For example, the record transfer tool 112 may receive settings for scheduling future and/or periodic data transfers between the defect data collection tool 104 and the database 114 structured to be accessible by the defect data analysis tool 116.

The configuration of the record transfer tool 112 may be reusable for subsequent defect data transfers between the customer database 106 and the database 114 structured for ODC. In this manner, subsequent analyses of similar defect data may be performed with minimal additional configuration.

In step 210, the defect data is transferred to the database structured to be accessible by an ODC analysis tool. More specifically, the record transfer tool 112 may employ a mapping to transfer fields of data from the customer database 106 to corresponding fields of data in the database 114 structured to be accessible by the defect data analysis tool 116, and therefore, structured for ODC. However, the record transfer tool 112 may employ the mapping to transfer data (e.g., initially or as updates) between the customer database 106 and the database 114 structured to be accessible by the defect data analysis tool 116 in a different manner. For example, data from one table of the customer database 106 may be mapped to multiple tables in the database 114 structured to be accessible by the defect data analysis and vice versa. In this manner, defect data collected by the customer defect data collection tool 104 is transferred to the database 114 structured for ODC. In this manner, the record transfer tool 112 and database 114 structured to be accessible by the defect data analysis tool 116 may import data from any type of customer defect management repository and streamline the data import process. More specifically, the record transfer tool 112 and database 114 may enable quick, efficient and accurate transfer of data between any defect management repository and the database 114.

In step 212, ODC analysis is performed on the defect data using an ODC analysis tool. For example, a defect data analysis tool 116 such as jMYSTIQ may be employed for processing and/or analyzing the defect data stored in the database 114 structured to be accessible by the defect data analysis tool 116. The analysis performed by the defect data analysis tool 116 may assist the customer in reducing defects in the customer's subsequent software release.

Thereafter, step 214 may be performed. In step 214, the method 200 ends. Additionally, in some embodiments, data output from the defect data analysis (e.g., ODC) tool 116 may be validated. For example, the defect data analysis tool 116 may validate the defect data before step 212 in which ODC analysis is performed on the defect data using the data defect data analysis tool 116. In this manner, the defect data analysis tool 116 may ensure such data is the data required for ODC, thereby ensuring accuracy of the data. Through use of the method 200, a customer may overcome the complexity of employing ODC to analyze defect data.

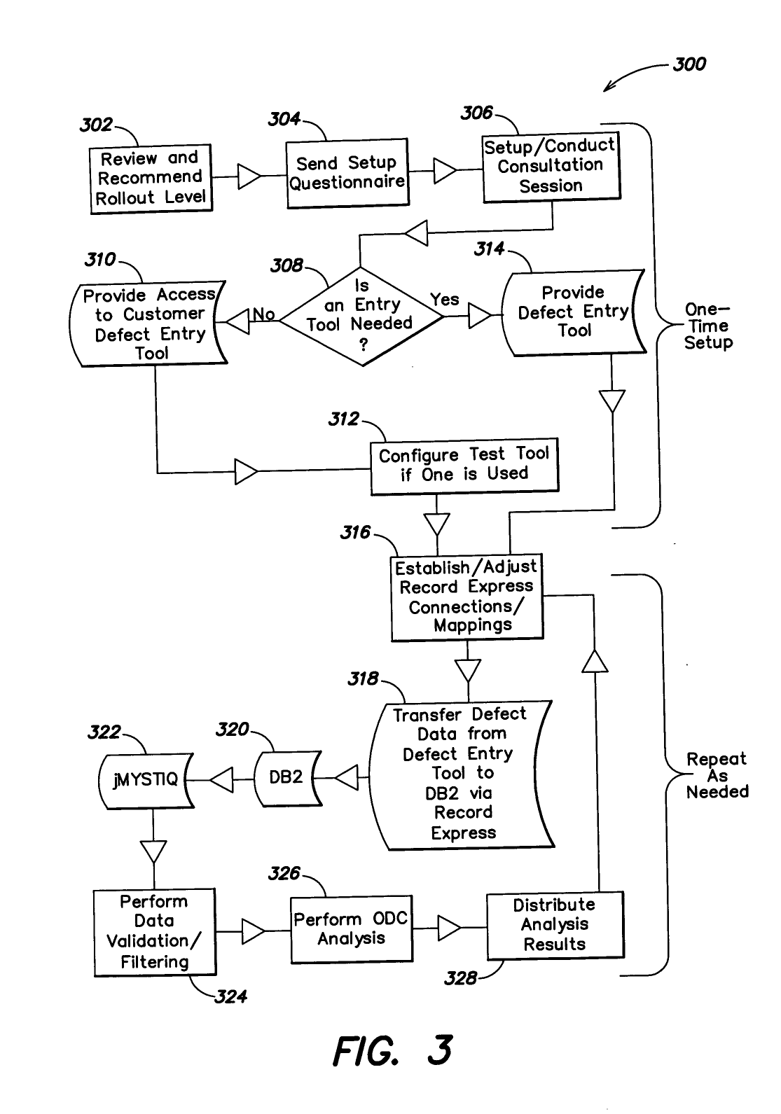

FIG. 3 illustrates a process flow for a second exemplary method of providing a service for performing Orthogonal Defect Classification (ODC) analysis in accordance with an embodiment of the present invention. With reference to FIG. 3, in step 302, the method 300 may begin by a review and recommendation of a rollout level. More specifically, the service provider may meet with a customer to whom the service for performing ODC analysis is provided. During this meeting the service provider may determine the customer's desired level of involvement while providing the service for performing ODC analysis. More specifically, the service provider may determine an amount of resources the customer is willing to commit for providing the service. For example, the customer may invest their own resources to perform some or most of the work. Alternatively, the customer may not be willing to commit any resources, and therefore, may prefer that the service provider performs all of the work. Based on this information, the service provider may recommend a rollout level indicating how the service for performing ODC analysis will be provided. The information described above is exemplary, and therefore, it should be understood that additional and/or different information may be reviewed to recommend an appropriate rollout level for the customer.

In step 304, a setup questionnaire may be sent to the customer. The setup questionnaire may pose questions to and/or request documentation from the customer which may assist the service provider in providing the service for performing ODC analysis to the customer.

### General Project Overview

The service provider may ask questions to and/or request documentation from the customer about test phases defined by the customer. Defined test phases may include a unit test, component configuration test, component function verification test (CFVT), component system integration test (CSIT), solution system integration test (SSIT), customer user acceptance/performance/stress test, and a first-ninety-days-in-production test. Although the customer may define a larger or smaller number of test phases and/or different test phases.

Additionally or alternatively, the service provider may ask questions to and/or request documentation from the customer about the scope of their software project, schedule of the project and software release history. In this manner, the service provider may then assess feasibility of implementation model options.

Additionally or alternatively, the service provider may ask questions to and/or request documentation from the customer about test plans. For example, copies of all test plans may be required for assessing the customer's organizational testing maturity. In this manner, the following questions may be answered:
Are severity levels/defect turnaround times defined?
Are Entry/Exit Criteria identified?
Does the test coverage strategy logically map to the purpose of the test?
Is there a published coverage strategy and/or a requirements to test case traceability matrix?

Additionally or alternatively, the service provider may ask questions to and/or request documentation from the customer about test organization roles and/or responsibilities. In this manner, test phase ownership may be defined. More specifically, it may be determined whether the test plans of one team overlap in coverage and/or conflict with the test plans of another team. Consequently, duplicative efforts and/or coverage gaps across project teams involved in testing activities may be avoided.

Additionally or alternatively, the service provider may ask questions to and/or request documentation from the customer about key metrics that are collected and/or reported by the customer. The key metrics collected and/or reported may include a number of change requests (CRs), a number of defects and a number of release requirements, which may be adjusted to account for CR impact. Although a larger or smaller number of metrics and/or different metrics may be collected and/or reported.

Additionally or alternatively, the service provider may ask questions to and/or request documentation from the customer about special customer focus areas. In this manner, the service provider may identify problems related to special customer focus areas that may need to be addressed. During this time, the service provider may discuss with the customer metrics that may be necessary to support the customer focus areas.

### Existing Defect Management and/or Analysis Processes

Additionally or alternatively, the service provider may ask questions to and/or request documentation from the customer about a test tool used by the customer to execute test cases and capture and/or manage defects. Technical information such as the tool platform, user levels defined, etc. may be discussed. However, a larger or smaller amount and/or different technical information may be discussed.

Additionally or alternatively, the service provider may ask questions to and/or request documentation from the customer about an exemplary test case including required and optional fields. In this manner, the service provider may verify that expected and actual results are recorded and may verify scripts are at a transaction level.

Additionally or alternatively, the service provider may ask questions to and/or request documentation from the customer about an exemplary defect record, including required and optional fields. In this manner, the service provider may verify that a clear problem statement is recorded in every defect and may verify that a clear resolution statement is recorded in every defect.

In some embodiments, the service provider may ask questions to and/or request documentation from the customer about a defect management process flow. In this manner, the service provider may obtain information about turnaround times, severity levels, root cause analysis, and/or where invalid and/or rejected criteria fit into the existing defect management process. The service provider may evaluate and size a consult effort to determine if add-on services should be offered to fill any gaps. Additionally, test execution management consulting may be sized as an add-on services offering.

Additionally or alternatively, the service provider may ask questions to and/or request documentation from the customer about currently collected defect reporting metrics. In some embodiments, a number of functional release requirements, which may include the impact of change requests, and a number of severity 1 and 2 defects per release requirement for historic similarly-sized projects may be collected.

In some embodiments, the service provider may ask questions to and/or request documentation from the customer about special customer focus areas. In this manner, the service provider may identify problems related to special customer focus areas that may need to be addressed. During this time, the service provider may discuss with the customer metrics that may be necessary to support the customer focus areas.

### DRM Setup/Consultation

Additionally or alternatively, the service provider may discuss with the customer how ODC may improve the customer's defect removal strategy. In this manner, the customer's mindset may change from how many defects should be removed to where attention should be focused and how to determine success.

In some embodiments, the service provider may discuss with the customer whether the prior release was successful and/or whether significant process changes are necessary. For example, the service provider may discuss with the customer any special areas of customer concern, quality improvement goals and/or cost avoidance goals. Minimum quality improvement objectives may include finding and fixing more than half of an entire lifecycle of defects within development phase tests and activities before solution level integration testing. The service provider may determine whether the project may achieve the above as a short term goal and whether the customer's organization may achieve the above as a long term goal. Minimum quality improvement objectives may also include realizing a reduction in the percentage of defect escapes to production relative to the last comparably-sized release (although minimum quality improvement objectives may be different).

Additionally or alternatively, after completing an ODC setup configuration construction, the service provider may discuss a map to roles and responsibilities with the customer. The service provider may also address any work overlaps and/or gaps between one or more customer teams. In this manner, the service provider may assess whether duplicative test cases are being executed across test phases, assess regression test strategy for coverage effectiveness and/or ensure each test phase focuses on the right type of testing (e.g., function versus system integration).

In some embodiments, a new ODC setup configuration may be constructed using historical data or as appropriate. The service provider may identify the process model which was followed (e.g., waterfall, iterative, spiral, etc.) in the project for which the historical defect data is available (or create new if not available). A defect-type setup configuration may be constructed by using historical, classified defects from the previous release, selecting all defects which were uncovered during the development process (excluding customer-reported defects), sorting the records by the ‘activity’ field, within each activity, sorting by defect-type, and/or calculating the percent distribution of defect-types within each activity. The total percent within each activity should equal 100. A trigger setup configuration may be constructed in a similar manner. More specifically, the trigger setup configuration may be constructed using the same process described above, substituting trigger for type.

It should be understood that the questionnaire described above is exemplary, and therefore, a larger or smaller number of questions and/or different questions may be posed by the questionnaire. Additionally or alternatively, a larger or smaller amount of and/or different documentation may be requested from the customer to assist the service provider in providing the service for performing ODC analysis to the customer.

In step 306, a customer consultation may be scheduled and conducted. More specifically, the service provider may coordinate with the customer to schedule the consultation. During the consultation, the service provider may gather information that may be required by the record transfer tool 112 for transferring defect data between the defect data collection tool 104 and the database 114 structured to be accessible by the defect data analysis tool 116. For example, the service provider may obtain data source, mapping, selection criteria and/or scheduling information from the customer. Although specific information is described above, the service provider may obtain, a larger or smaller amount and/or different type of information. For Lotus Notes databases, data source information such as server, host and/or path may be obtained. The host information may be for connection document purposes. Alternatively, for relational (e.g., DB2) databases, data source configuration may be based on DB2 connect standards. Therefore, data source information such as host, port, database name, and/or type (e.g., AS/400, MVS, etc.) may be obtained. Additionally, the service provider may obtain information mapping information such as a table that maps tables in the database 114 structured to be accessible by the defect analysis tool 116 to source (e.g., customer database 106) tables. For example, each entry in the mapping table may include a destination field (e.g., Dest. Field) of a destination table (e.g., Dest. Table) and a corresponding source field (e.g., Src. Field) of a source table (e.g., Src. Table) to which the destination field is mapped.

Additionally, the service provider may obtain information about the criteria used to select data for transfer between the defect data collection tool 104 and the database 114 structured to be accessible by the defect data analysis tool 116. Further, the service provider may obtain information about a frequency (e.g., daily, weekly, monthly, etc.) with which data is to be transferred (e.g., updated) between the defect data collection tool 104 and the database 114 structured to be accessible by the defect data analysis tool 116.

It should be understood that during the consultation, the service provider may gather a larger or smaller amount of information and/or different information required by the record transfer tool 112 for transferring defect data between the defect data collection tool 104 and the database 114 structured to be accessible by the defect data analysis tool 116.

In step 308, it is determined whether a defect entry tool may be required. A defect entry tool may be required if a customer does not have a defect data collection tool 104 or is unable or unwilling to modify their defect data collection tool 104. For example, if the customer's defect data collection tool 104 is provided by a vendor, the customer may be unable to modify the tool. Further, a customer may be unwilling to invest resources to modify the defect data collection tool 104. A defect entry tool 118 (shown in phantom in FIG. 1) may serve as a user interface to a database 120 (shown in phantom in FIG. 1) coupled thereto and/or included therein to which customer defect data may be transferred from the customer database 106. Data required for ODC may be appended to the data transferred to and stored in the database 120 coupled to the defect entry tool 118.

If in step 308, it is determined a defect entry tool is not required, the customer may have a defect data collection tool 104 which may be modified. Therefore, step 310 may be performed. In step 310, the customer may provide the service provider access to the customer defect data collection tool 104. In this manner, the service provider may determine how to configure to the customer's defect data collection tool 104 for ODC.

In step 312, the defect data collection tool 104 may be configured for ODC. For example, the service provider may assist in configuring the customer defect data collection tool 104 to collect fields of information that are required for ODC. The service provider may perform some, most or all of the work required to configure the customer defect data collection tool 104. In this manner, the work required by the customer for providing the service for performing ODC analysis is reduced. Thereafter, step 316 may be performed.

Alternatively, if, in step 308, it is determined that a defect entry tool is required, step 314 may be performed. In step 314, the service provider may provide the customer with a defect entry tool 118. Customer defect data may be transferred (e.g., from the customer defect data collection tool 104) to the defect entry 118 tool. Additional data which may be required for ODC may be appended to the data stored in the defect entry tool 118. Thereafter, step 316 may be performed.

In step 316, the record transfer tool may be configured. More specifically, the service provider may employ information obtained from the questionnaire and/or during the setup consultation for data transfer settings. For example, such data transfer settings may specify how to establish and/or adjust connections and/or mappings employed by the record transfer tool 112 to transfer data between the defect data collection tool 104 and the database 114 structured to be accessible by the defect data analysis tool 116. The data transfer settings may also indicate a frequency (e.g., daily, weekly, monthly, etc.) with which data may be transferred (e.g., automatically) between the defect data collection tool 104 and the database 114 structured to be accessible by the defect data analysis tool 116. Additionally or alternatively, different data transfer settings may be based on information obtained from the questionnaire and/or during the setup consultation for data transfer settings.

In step 318, the record transfer tool 112 may transfer defect data from the customer defect data collection tool 104 or the defect entry tool 118 provided by the service provider to the database 114 structured to be accessible by the defect data analysis tool 116. More specifically, if, in step 308, it is determined a defect entry tool may be required, the record transfer tool 112 may transfer defect data from the defect entry tool 118 provided by the service provider to the database 114 based on the data transfer settings. Alternatively, if, in step 308, it is determined a defect entry tool may not be required, the record transfer tool 112 may transfer defect data from the customer defect data collection tool 104 to the database 114 based on the data transfer settings. For example, based on the data transfer settings, the record transfer tool 112 may create a mapping between fields of data stored in the customer database 106 and fields of data stored in the database 114 structured to be accessible by the defect data analysis tool 116 and transfer data between the defect data collection tool 104 and the database 114 accordingly. As stated, the record transfer tool 112 may employ many permutations of mapping. For example, the record transfer tool 112 may map a single table from the customer database 106 to multiple tables in the database 114 structured to be accessible by the defect data analysis tool 116 (although other types of mapping may be employed).

In step 320, the data transferred to the database 114 may be stored in the database 114. In this manner, customer defect data may be configured for ODC and transferred to a database 114 that is structured to be accessible by the defect data analysis tool 116, and therefore, structured for ODC.

In step 322, the defect data analysis tool 116 may process the defect data stored in the database 114. The defect data analysis tool 116 may access the data stored in the database 114, process such data and output information (e.g., as charts) which may indicate defect frequency and trends.

In step 324, data validation may be performed on the output information. More specifically, the defect data analysis tool 116 may ensure accuracy of the output information. For example, the defect data analysis tool 116 may verify the output information is pertinent to the current customer defect analysis project. Unnecessary or unwanted data may be filtered.

In step 326, defect data analysis may be performed. More specifically, the defect data analysis tool 116 may perform ODC analysis on the output information. ODC analysis may yield a multi-faceted analysis which may provide insight into a customer's defect data project. For example, ODC analysis may provide insight into defect escapes, about how to fix defect escapes, project risk, test effectiveness, testing efficiency, customer satisfaction and/or readiness of a customer system for production. ODC analysis may propose solutions and customer actions for preventing future defects, and/or find defects earlier in the project lifecycle (compared to other defect analysis methods), thereby reducing costs.

In step 328, the results of the defect data analysis may be distributed. For example, the service provider may interpret the output of the defect data analysis performed by the defect data analysis tool 116 and distribute such interpreted results. For example, the service provider may present the interpreted results to the customer. Additionally or alternatively, the service provider may present the interpreted results to an internal team responsible for configuring the record transfer tool for future data transfers of the customer's data.

It should be noted in the process flow for the second exemplary method 300 of providing a service for performing ODC analysis, in some embodiments, steps 302-314 may be performed once during a setup stage. In contrast, steps 316-328 may be performed as needed (e.g., more than once). In this manner, results of a previous defect data analysis may be employed for a subsequent defect data analysis. For example, results of a previous defect data analysis may affect data transfer settings of the record transfer tool 112 for a subsequent defect data analysis. Alternatively, existing data transfer settings may be employed for the subsequent defect data analysis.

Through use of the method 300, a customer may overcome the complexity of employing ODC to analyze defect data. More specifically, the service provider may assist the customer in performing ODC analysis, and therefore, a large effort may not be required by customers to employ ODC for analyzing defect data.

The foregoing description discloses only exemplary embodiments of the invention. Modifications of the above disclosed apparatus and methods which fall within the scope of the invention will be readily apparent to those of ordinary skill in the art. For instance, although methods and apparatus of providing a service for performing ODC analysis are described above, the present invention may include methods for deploying computing infrastructure, comprising integrating computer-readable code into a computing system, the combination of which is capable of performing one or more steps of the method for providing the service for performing ODC analysis. For example, in a broad aspect, the present invention may include a method for deploying computing infrastructure, comprising integrating computer-readable code into a computing system, wherein the code in combination with the computing system is capable of (1) adapting a defect data transfer tool to transfer defect data from a defect data collection tool; (2) transferring the defect data to a database structured to be accessible by an ODC analysis tool; and (3) performing ODC analysis on the defect data using the ODC analysis tool. In this manner, a service provider may offer ODC to a customer as a test service. Further, the present methods and apparatus may enable adjustment to selectable parameters for ODC to adapt to a customer's specific situation. For example, data and/or environment type defects typically may not be selected for ODC (e.g., from ODC options). However, if a customer's testing may deal heavily with data and/or environment type defects, the present invention may enable changes to ODC selection options to include such defect type. In this manner, the present invention may facilitate a change to an ODC selection option during the data capture and/or analysis process. Additionally, although the present methods and apparatus are described above with reference to one or more test phases, the present methods and apparatus may be employed during any part of the product (e.g., customer's software) lifecycle (e.g., design, development and/or any test phase).

Through use of the present methods and apparatus, any customer (e.g., testing organization) regardless of the customer's testing maturity and platforms and/or test tools employed may adapt and employ ODC for their needs in an efficient and cost-effective manner. Therefore, the present invention may make ODC broadly deployable and/or accessible. In this manner, ODC may be employed for one or more test phases of a testing project of any size. Further, ODC may be employed to yield cross-release metrics and/or quality assessment insight which was previously unavailable. In some embodiments, the service provider may train the customer to perform ODC.

Accordingly, while the present invention has been disclosed in connection with exemplary embodiments thereof, it should be understood that other embodiments may fall within the spirit and scope of the invention, as defined by the following claims.

The invention claimed is:

1. A method of providing a service for performing Orthogonal Defect Classification (ODC) analysis, comprising:
querying a customer about a level of service desired for a customer defect analysis project;
configuring a customer defect data collection tool for ODC;
adapting a defect data transfer tool to transfer defect data from the defect data collection tool;
transferring the defect data to a database structured to be accessible by an ODC analysis tool; and
performing ODC analysis on the defect data using the ODC analysis tool.

2. The method of claim 1 wherein querying the customer about a level of service desired for the customer defect analysis project includes at least one of:
querying the customer about their desired level of involvement in providing the service; and
querying the customer about their defect analysis project.

3. The method of claim 2 further comprising creating data transfer settings based on querying the customer about their defect analysis project.

4. The method of claim 3 wherein transferring the defect data includes transferring the defect data based on the data transfer settings.

5. The method of claim 1 wherein configuring the customer defect data collection tool for ODC includes adjusting the customer defect data collection tool to collect data required by ODC.

6. The method of claim 1 further comprising validating data output from the ODC analysis tool.

7. The method of claim 1 wherein adapting the defect data transfer tool includes employing a reusable configuration to define the transfer of the defect data from the defect data collection tool to the database structured to be accessible by the ODC analysis tool.

8. A method for deploying computing infrastructure, comprising integrating computer-readable code into a computing system, wherein the code in combination with the computing system is capable of:
adapting a defect data transfer tool to transfer defect data from a defect data collection tool;
transferring the defect data to a database structured to be accessible by an ODC analysis tool; and
performing ODC analysis on the defect data using the ODC analysis tool.

9. The method of claim 8 wherein the code in combination with the computing system is further capable of at least one of:
receiving information obtained from queries to the customer about their desired level of involvement in providing the service; and
receiving information obtained from queries to the customer about their defect analysis project.

10. The method of claim 9 wherein the code in combination with the computing system is further capable of creating data transfer settings based on queries to the customer about their defect analysis project.

11. The method of claim 10 wherein the code in combination with the computing system is further capable of transferring the defect data based on the data transfer settings.

12. The method of claim 8 wherein the code in combination with the computing system is further capable of adjusting the customer defect data collection tool to collect data required by ODC.

13. The method of claim 8 wherein the code in combination with the computing system is further capable of validating data output from the ODC analysis tool.

14. The method of claim 8 wherein the code in combination with the computing system is further capable of employing a reusable configuration to define the transfer of the defect data from the defect data collection tool to the database structured to be accessible by the ODC analysis tool.

15. A system for performing orthogonal Defect Classification (ODC) analysis, comprising:
a defect data transfer tool;
an ODC analysis tool; and
a database structured to be accessible by the ODC analysis tool coupled to the defect data transfer tool and the ODC analysis tool;
the system is adapted to:
adapt the defect data transfer tool to transfer defect data from a defect data collection tool;
transfer the defect data to the database structured to be accessible by the ODC analysis tool; and
perform ODC analysis on the defect data using the ODC analysis tool.

16. The system of claim 15 wherein the system is further adapted to at least one of:
receive information obtained from queries to the customer about their desired level of involvement in providing the service; and
receive information obtained from queries to the customer about their defect analysis project.

17. The system of claim 16 wherein the system is further adapted to create data transfer settings based on queries to the customer about their defect analysis project.

18. The system of claim 17 wherein the system is further adapted to transfer the defect data based on the data transfer settings.

19. The system of claim 15 wherein the system is further adapted to adjust the customer defect data collection tool to collect data required by ODC.

20. The system of claim 15 wherein the system is further adapted to validate data output from the ODC analysis tool.

21. The system of claim 15 wherein the system is further adapted to employ a reusable configuration to define the transfer of the defect data from the defect data collection tool to the database structured to be accessible by the ODC analysis tool.

22. The method of claim 1 further comprising adjusting a selectable parameter for ODC.
